(19) United States
(12) Patent Application Publication
(10) Pub. No.: US 2003/0048286 A1
(43) Pub. Date: Mar. 13, 2003

(54) System and method for providing an enterprise oriented web browser and productivity environment

(76) Inventor: Ranjan Lal, Boston, MA (US)

Correspondence Address: LAHIVE & COCKFIELD, 28 STATE STREET, BOSTON, MA, 02109, US

(21) Appl. No.: 10/218,056

(22) Filed: Aug. 12, 2002

Related U.S. Application Data
(60) Provisional application No. 60/311,706, filed on Aug. 10, 2001.

(51) Int. Cl. G09G 5/00

(52) U.S. Cl. 345/700

(57) ABSTRACT

A method of reducing the complexity of managing information and coordinating information technology tools through the use of a enterprise oriented browser and productivity environment is disclosed. A specialized software application (“Research-Desk”), coordinates, manages, and extends individual information technology applications and makes the combined superset of features of those applications available through a single user-interface. Research-Desk communicates with, and hosts the underlying applications in such a way as to make the end-user experience similar to that of a single seamless application. The hosting mechanism of Research-Desk uses applications that can act as DocObject servers, software objects that can act as ActiveX Controls, Windows Single Document Interface (WIN-SDI) applications, and Windows Multiple Document Interface (WIN-MDI) applications. Research-Desk also enables software developers to develop subsets of applications with features that are targeted to knowledge workers in specific tasks which may then be hosted by Research-Desk thereby integrating its functionality with that of other software components or applications also hosted by Research-Desk

### RELATED AND PRIORITY APPLICATIONS

The present application claims priority to a U.S. provisional application Serial No. 60/311,706 filed on Aug. 10, 2001.

### FIELD OF THE INVENTION

The illustrative embodiment of the present invention relates generally to computer systems and more particularly to an enterprise oriented web browser and productivity environment.

### BACKGROUND OF THE INVENTION

Individuals engaged in knowledge and information oriented tasks (“knowledge workers”)—such as consulting, research, analysis, journalism, law, academics, among others—use a wide variety of information technology tools to facilitate and manage information. Most commonly, the tools include an e-mail client application such as Microsoft Outlook™, a web browser such as Netscape Navigator™ or Microsoft Internet Explorer™, and productivity applications such as Microsoft Word™, Microsoft Excel™, and Microsoft PowerPoint™. In addition to the aforementioned applications, knowledge workers also use utility applications such as WinZip™ and Microsoft Windows Explorer™ to manage the documents or files containing relevant information.

The demands and requirements placed on the information technology tools have become significantly greater due to the easy availability of great quantities of information and documents on the Internet and on corporate intranets. As a result, the knowledge worker has to not only manage the information, but also manage and coordinate the information technology tools to process and analyze information effectively. Examples of tasks to coordinate information technology tools include switching between applications, locating, opening and closing documents, organizing documents into folders, and transferring data from one application to another. As a corollary to the trend towards increasing complexity in both the information and the tools required to manage the information, typical software developers find it increasingly difficult to develop standalone applications that add value above and beyond the additional effort of managing yet another application.

### BRIEF SUMMARY OF THE INVENTION

The illustrative embodiment of the present invention provides a method for reducing the complexity of managing information and coordinating information technology tools. A specialized software application (“Research-Desk®”), coordinates, manages, and extends individual information technology applications and makes the combined superset of features of those applications available through a single user-interface. Research-Desk communicates with, and hosts the underlying applications in such a way as to make the end-user experience similar to that of a single seamless application. The hosting mechanism of Research-Desk uses applications that can act as DocObject servers (examples of which include Microsoft Excel™, Microsoft Word™), and software objects that can act as ActiveX Controls (examples of which include the Microsoft Windows Media Player™ ActiveX Control, the Adobe Acrobat™ ActiveX Control, the Flash Player™ ActiveX Control). Research-Desk enables software developers to develop subsets of applications with features that are targeted to knowledge workers in specific tasks which may then be hosted by Research-Desk thereby integrating its functionality with that of other software components or applications also hosted by Research-Desk

In one embodiment of the present invention, an electronic device executes more than one application. Each application generates at least one document. A graphical user interface provides access to each of the documents generated by the applications without having to activate each application upon switching. Multiple active windows in the graphical user interface display objects generated by the applications.

In another embodiment of the present invention, an electronic device executes more than one application. Each application generates at least one Active X document. A graphical user interface provides access to each of the Active X documents generated by the applications without having to activate each Active X document upon switching. Multiple active frame windows in the graphical user interface display the Active X documents generated by the applications.

### BRIEF DESCRIPTION OF THE DRAWINGS

FIG. 1 depicts a block diagram of an environment suitable for practicing the illustrative embodiment of the present invention;

FIG. 2 is a flowchart of the sequence of steps performed by the illustrative embodiment of the present invention during component initialization.

FIG. 3 is a block diagram of a user interface provided by the illustrative embodiment of the present invention allowing a user to selectively save documents within a workspace;

FIG. 4 is a block diagram of the illustrative embodiment of the present invention simultaneously hosting two active applications;

FIG. 5 is a flowchart of the sequence of steps performed by the illustrative embodiment of the present invention to implement parallel active frame window simultaneously;

FIG. 6 is a flowchart of the sequence of steps performed by the illustrative embodiment of the present invention to implement a menu proxy object;

FIG. 7 is a block diagram of the data flow through an Active X adapter;

FIG. 8 is a block diagram of an Active X control host hosting an Active X document without replacing the control host menus;

FIG. 9 is a flowchart of the sequence of steps performed by the illustrative embodiment of the present invention to deter selected popup windows; and

FIG. 10 is a flowchart of the sequence of steps performed by the illustrative embodiment of the present invention to cache web pages; and

FIG. 11 is a block diagram of the Research-Desk browser used to implement Smart-Forward technology.

FIG. 12 is a block diagram of how Research-Desk hosts Windows SDI and Windows MDI applications.

### DETAILED DESCRIPTION

The illustrative embodiment of the present invention provides a method for reducing the complexity of managing information and coordinating information technology tools. A specialized software application coordinates, manages, and extends individual information technology applications and makes the combined superset of features of those applications available through a single user-interface. The specialized software application, known as “Research-Desk”, communicates with, and hosts the underlying applications in such a way as to make the end-user experience similar to that of a single seamless application. The hosting mechanism of Research-Desk uses applications that can act as DocObject servers, software objects that can act as ActiveX Controls, Windows Single Document Interface (WIN-SDI) applications, and Windows Multiple Document Interface (WIN-MDI) applications. Research-Desk also enables software developers to develop subsets of applications with features that are targeted to knowledge workers in specific tasks. Research-Desk may then host such a software component and integrate its functionality with that of other software components or applications hosted by Research-Desk.

The illustrative embodiment of the present invention allows an end-user to perform multiple project management related tasks in one application. For example, the end-user is able to open and edit various kinds of documents pertinent to a particular project. Alternatively, the user is able to manage communications related tasks—such as email, instant messaging, video conferencing, and contact management from within a single application. An enterprise oriented browser enables the end-user to edit and view popular document types including web pages, Excel™ spreadsheets, Word™ documents, PowerPoint™ presentations, Portable Document and other popular kinds of documents. The documents may be displayed side by side and may be saved in any of the active formats in the workspace (i.e. a web page may be saved as a Word™ document). Content, text and images, may be drag and dropped or copied and pasted from one application to another. A user is able to search across all of the open documents with a single command. Functionality from one application may be used in another as in the case of language translation capability from one hosted document being used to translate a document in asecond application lacking the feature.

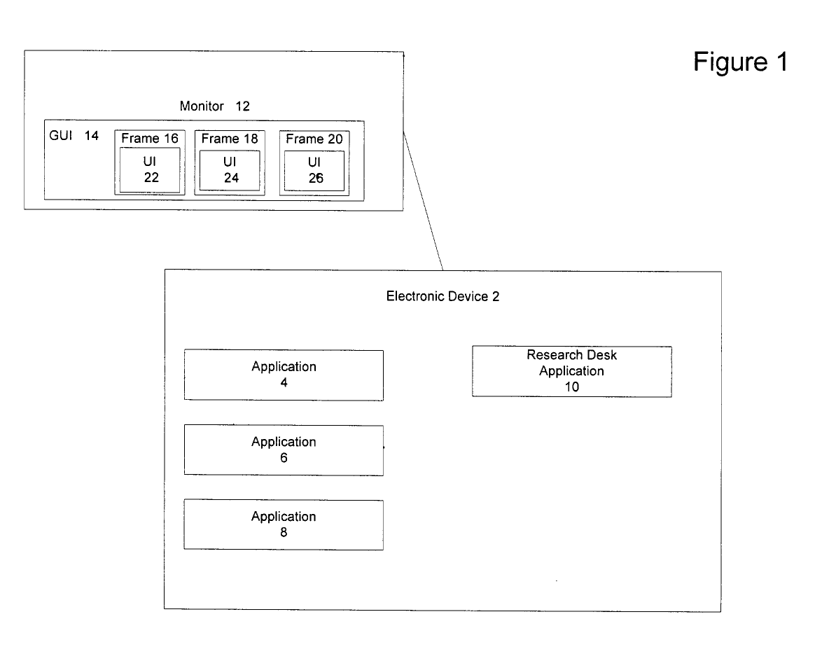

FIG. 1 depicts a block diagram of an environment suitable for practicing the illustrative embodiment of the present invention. An end-user 1 accesses an electonic device 2 executing multiple applications 4, 6 and 8. Each application 4, 6 and 8 generates a viewable object such as an Active X control, an Active X document or a standard Windows document/application window. User interfaces for the viewable objects 22, 24 and 26 are displayed on a graphical user interface 14 presented on a monitor 12 interfaced with the electronic device 2. The research desk application 10 executing on the electonic device 2 produces the graphical user interface 14 and three separate frame windows 16, 18 and 20 within the graphical user interface which are used to display the user interface for the viewable objects 22, 24 and 26.

The end-user can also annotate web pages while browsing and then save or email the edited page. For example, if the end-user encounters an article on the web that he would like to keep for reference, he can save a personal copy of the entire web page HTML, images, Java, frames, stylesheets, etc.—as a single file. Although the end-user could have bookmarked the web page (using the Favorites feature), a saved copy of the web page means that the end-user can refer to the web page at anytime, without an internet connection, and is no longer dependant on the web site maintaining that page.

The browser has an integrated file-transfer manager, the web browser feature most often demanded by end-users. The end-user can download several files simultaneously from any kind of web server—FTP, HTTP, HTTPS (secure server), and even pause and resume downloads.

The end-user can even download web pages for future browsing without an Internet connection. For example, a user can “WebSync” the New York Times web page—and its links—in minutes. Then on an airplane or hotel, or even on the daily commute home, browse the synced web pages at leisure. This is a significant benefit to today's business users who travel more than ever and do not necessarily have an Internet connection available over the course of their entire day.

Applications that host software components (add-ons) to add functionality on the-run (i.e., add/remove functionality while the host application is running) usually require the components to follow specific guidelines and implement certain binary standards (e.g. implement the ActiveX Control binary standard or the ActiveX Document binary standard). Most application designers choose one of two paths when designing hosting capabilities—either require the component to implement a preexisting binary standard, or require the component to implement an application specific binary standard (i.e., the component has to be custom tailored for the host). Each approach has its advantages and disadvantages. If a host application implements a preexisting binary standard for components, there is often a wide choice of preexisting components. Also, existing software development tools often provide specific features that reduce the effort required to author components based on the preexisting standards. On the other hand, because preexisting binary standards are not necessarily designed with that particular host in mind, and because the preexisting binary standards are rarely designed with on the-run integration (i.e., add/remove components) capabilities, there are tradeoffs in performance, resource utilization, and functionality. Alternatively, if a host application implements a custom specification for components, there is significantly greater potential for maximizing performance and functionality while minimizing resource utilization. However, standard off-the-shelf components cannot be used; components have to be custom designed. This is the approach taken by many applications including AutoCAD™, Adobe Photoshop™, WinAmp™, and others.

Research-Desk's multi-component system is a hybrid of both alternatives. Components are based on preexisting binary standards. Research-Desk hosts components based on two of the most popular binary standards—ActiveX Controls and ActiveX Documents—and provides conversion (see description of ActiveX Adapter Technology below) between the two binary standards to maximize the usefulness of components authored via either of the two binary standards. To allow customization, Research-Desk allows the standard components to implement Research-Desk specific standards alongside the already implemented binary standards. The Research-Desk specific standards allow further customization of the behavior of the components. Customization is accomplished via two elements based on two other standards—the IDispatch binary standard and the XML information description standard. Research-Desk's multi-component system can also host Windows applications that do not adhere to any component based binary standards, as long as the hosted applications either use Active Accessibility or standard Windows menus and toolbars.

IDispatch is an interface already implemented by a majority of ActiveX Controls and the majority of ActiveX Documents. IDispatch allows Research-Desk to ‘discover’ the API of the software component. Research-Desk requires software components to use a small XML file (called the Initialization Sequence, it is typically between 10 and 20 lines) to describe the required IDispatch calls to initialize the otherwise generic component for the specific requirements of the Research-Desk environment. This technique provides free customization of preexisting and previously generic ActiveX Controls and ActiveX Documents simply via the use of a 10 to 20 line XML file. Another XML file—called the Menu Description—describes the menu and toolbar functions implemented by the component.

The illustrative embodiment of the present invention also allows software components to implement a custom binary standard to further optimize their performance and resource utilization. Software components can implement the IRDDocument interface to further customize their behavior. The IRDDocument interface is designed to be used with document-oriented components and can be used with ActiveX Controls and ActiveX Documents. This means that any standard component based on the ActiveX Control or the ActiveX Document binary standard can be customized for the Research-Desk environment without modifying the component itself. The Initialization Sequence XML file can initialize the component to a state most suitable for use with Research-Desk. Then, menu and toolbar commands can be customized and routed via the Menu Description XML file. Then, if further customization is required, the component developer can implement IRDDocument. To make implementation of IRDDocument easier, Research-Desk includes a software adapter that implements IRDDocument and hosts any ActiveX Control. Those skilled in the art will recognize that other binary standards may be integrated into Research-Desk in a similar manner without departing from the scope of the present invention. For example, components based on Microsoft's NET architecture can be hosted in Research-Desk when accompanied with appropriate MetaData or the appropriate Initialization Sequence XML File and the Menu Description XML File.

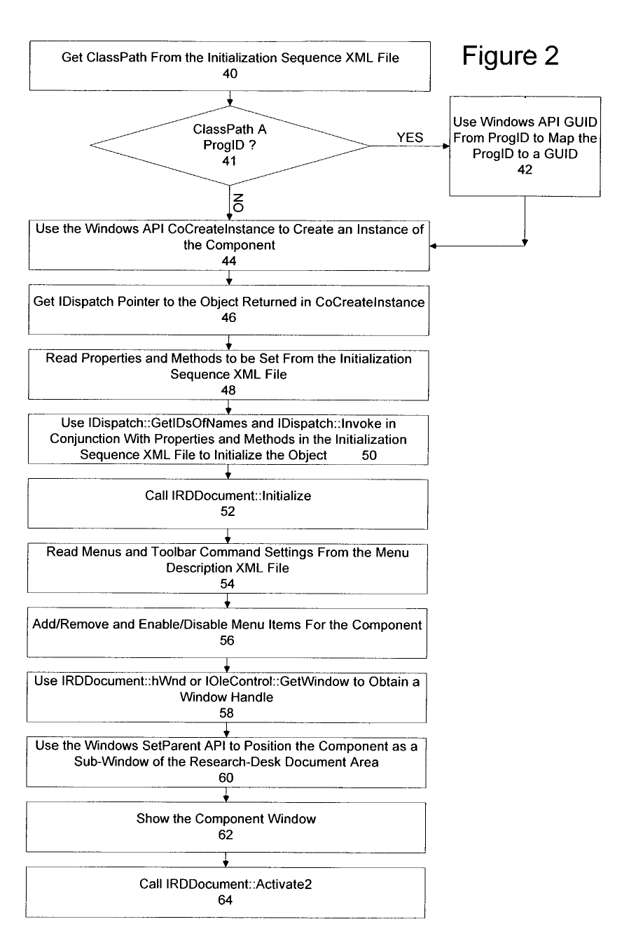

FIG. 2 is a flowchart of the sequence of steps performed by the illustrative embodiment of the present invention during component initialization. The initialization sequence XML file is examined to retrieve a class path (step 40). A determination is made as to whether the ClassPath is a ProgID (step 41). If the ClassPath is a ProgID, the Windows API GUID (globally unique identifier)maps from the ProgID to a GUID (step 42). The Windows API CoCreateInstance is then used to create an instance of the component (step 44). If the ClassPath is not a ProgID, the mapping step is skipped and the Windows API CoCreateInstance is used to create an instance of the component (step 44). The Idispatch Pointer to the object is returned in CoCreateInstance (step 46) and the properties and methods to be set are read from the initialization sequence XML file (step 48). The object is then initialized by using Idispatch::GetIDsOfNames and Idispatch::Invoke in conjunction with properties and methods in the Initialization Sequence XML file (step 50). IRDDocument::Initialize is called (step 52) and the menus and toolbar command settings from the menu description XML file are read (step 54). Based on the menu description XML file, menu items are added/removed and enabled/disabled for the component (step 56). IRDDocument::hWnd or IoleControl::GetWindow are then called as appropriated to obtain a window handle (step 60). The component window is then shown (step 62) and IRDDocument::Activate2 called to activate the window (step 64).

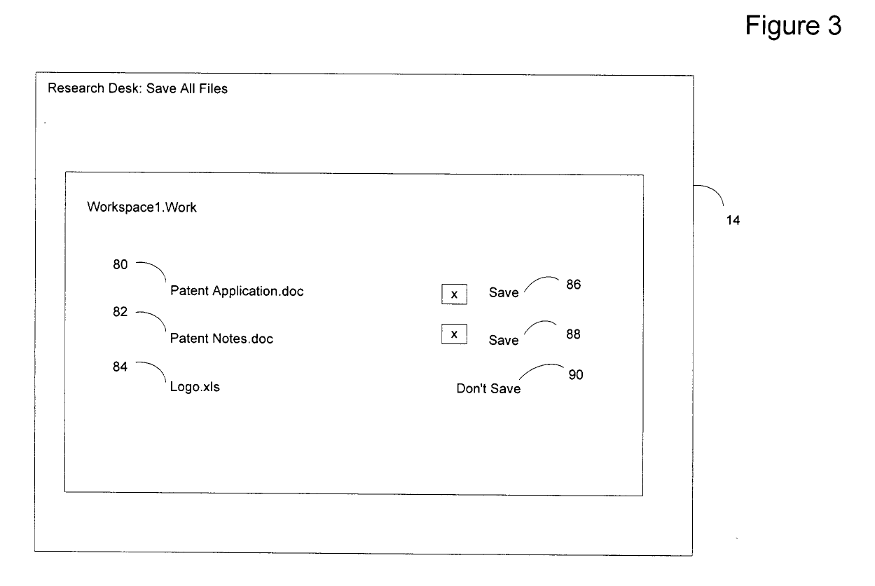

The collection of open documents being used by the end user (web pages, Word™ documents, Excel™ spreadsheets, etc.) is collectively referred to as the “workspace”. The end-user is able to open and save documents individually, and also able to save the entire workspace as a self-contained file. The end-user can therefore create a workspace for each thread of activity—for example, a workspace for each project, or a workspace for each report. Collaboration between users becomes simpler because collaborators can e-mail whole workspaces. The emailing of the workspace not only eliminates the requirement of emailing each document separately, but also preserves the organization of the workspace. The Save All Documents Function Research-Desk supports the industry-standard methods for saving individual documents—e.g. CTRL+S or File, Save to save a document. In addition to supporting commands for saving individual documents, Research-Desk also allows the end-user to save all open documents with a single command—e.g., CTRL+SHIFT+S or File, Save All. This command will save all open documents without prompting or after presenting a dialog box as shown below. Alternatively, the end-user 1 can click on the files listed in a dialog to assign filenames and folder locations. The end-user can also click on ‘Save’ column and check/uncheck the documents to be saved. FIG. 3 depicts a block diagram of a graphical user interface 14 produced by research desk which enables a user 1 to selectively save three listed viewable objects which are currently open in the workspace 80, 82 and 84 by depressing or not depressing an associated control 86, 88 and 90.

The illustrative embodiment of the present invention enables a single application to open and edit many different kinds of documents simultaneously. Multiple applications are available through a common user interface, and features from specific hosted applications can be made available across all hosted applications. For example, the end-user can search across all open documents (whether they are a web page, a Word document, a PowerPoint presentation, or any other kind) simultaneously. Research-Desk generates a hyper-linked list of all occurrences of the search word with surrounding context. The end-user can scroll through the search results and click on any entry to instantly view the corresponding document and occurrence of the searchword. The knowledge of hosted applications makes many other kinds of cross-application features possible. Drag/Drop and Copy/Paste functionality between different types documents (Microsoft Word, web page, Microsoft Excel) is provided using built-in support in Microsoft Windows Operating Systems. Specific features from one application available in other applications—for example spell and grammar checking from Microsoft Word can be made available in File Save dialogs (i.e., to help spell file names correctly).

Microsoft's DocObject Technology (also known as ActiveX Documents) allows applications to host live (i.e. editable) documents provided by other applications. The application hosting the document is known as the client (or host) and the application providing the document viewing and editing capabilities is known as the server. This technology can be used in many situations—for example, the technology can allow the end-user to view and edit a spreadsheet in a web browser. In that situation, Microsoft's Internet Explorer (the web browser) acts as the client (host) for the spreadsheet that is served by Microsoft Excel (acting as the server). To facilitate this behavior—known as In-Place-Editing—DocObject technology requires that both host and server implement specific COM (Component Object Model) interfaces. The DocObject specification assumes that the host will require the server to display its toolbars in the main window (not necessarily the document window) and that the host will never have two objects simultaneously In-Place-Active.

The limitation that only one object may be In-Place-Active causes a number of problems. There is a visual flash and noticeable (between approximately 0.5 and 5 seconds) delay when switching between documents in a Multiple Document Interface host. Undo states are lost at each switch—the end-user cannot undo actions if they switch between documents. Toolbars are added/removed from the Main Frame when switching between documents—resulting in a disconcerting visual flash and the document windows often move 1 or more inches up then down as the toolbars are switched. As only one document is active at a time, there is no easy way to facilitate drag/drop between documents.

The illustrative embodiment of the present invention allows multiple objects to be In-Place-Active, thereby allowing the end-user to have multiple documents readily and instantaneously accessible. “Parallel-Frame-Technology”, used by the illustrative embodiment of the present invention creates a separate COM object that implements IOleInPlaceFrame for each document window. The implementation of IoleInPlaceFrame for each document window means that the server application believes that each document is being hosted in a separate application. Since there are no limitations on how many documents can be In-Place-Active in total (the limit is 1 in each host; there are no limits on the server side), every document hosted by Research-Desk is In-Place-Active.

Having multiple windows be In-Place-Active results in several benefits versus the traditional Multiple Document Interface described above. Instant, flash-free, switching between documents is possible with multiple windows In-Place-Active. Undo states are preserved as long as the document is open. Full control over where the server's toolbars are located and when they are shown/hidden becomes possible as well as easy drag/drop between documents.

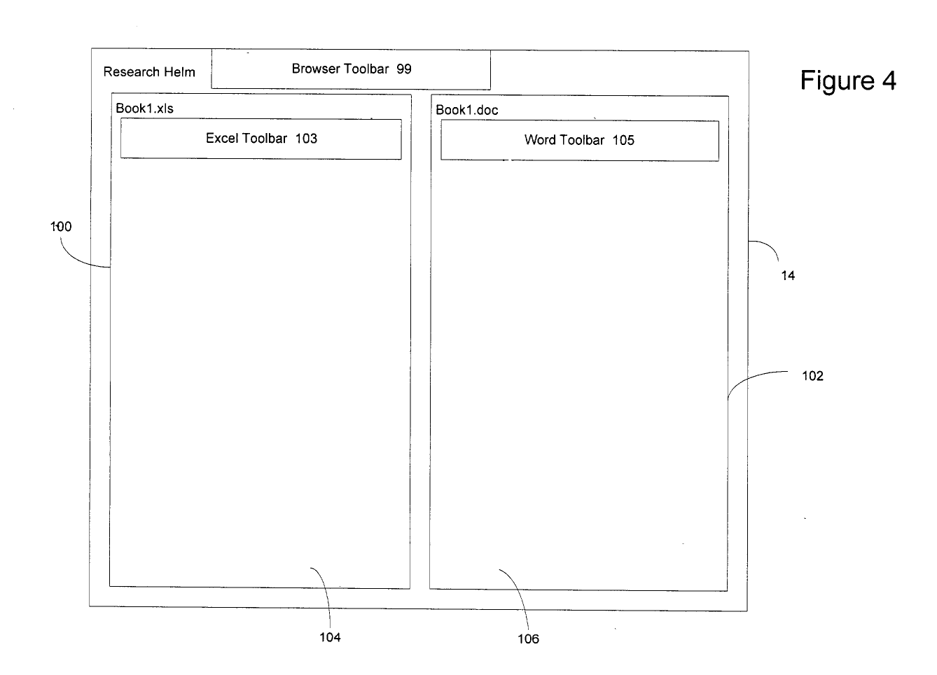

FIG. 4 depicts a block diagram of the graphical user interface 14 produced by the illustrative embodiment of the present invention. Two windows 100 and 102 are displayed in the graphical user interface. The two windows 100 and 102 are simultaneously In-Place-Active and hosting two viewable objects 104 and 106, an Excel spread sheet and a Word document.

Any application capable of hosting DocObjects implements a “frame” (typically by implementing the COM interfaces—IOleInPlaceFrame and IoleCommandTarget). Traditional host applications such as Microsoft Binder and Microsoft Internet Explorer expose only one object (typically corresponding to the main application window) that implements IOleInPlaceFrame. Therefore, all hosted DocObjects are contained in the same frame. Because the DocObject specification allows only one DocObject to be In-Place-Active at a time, traditional host applications such as Microsoft Binder or Internet Explorer only allow the end-user to view and edit one document at a time. The Parallel-Frame technology utilized by the illustrative embodiment of the present invention provides a separate frame for each contained DocObject. Each DocObject contained in the Research-Desk environment is simultaneously In-Place-Active. Each of the child windows in the Research-Desk environment implements a separate IOleInPlaceFrame—thereby freeing Research-Desk from the restriction of only having DocObject In-Place-Active at a time. Therefore, the end-user can edit and view DocObject windows side-by-side simultaneously.

In a traditional Single Document Interface (SDI) Host Application, the main application window is the only window and it implements:

IOleInPlaceFrame

IOleCommandTarget

IAdviseSink

IOleClientSite

IOleDocumentSite

IOleInPlaceSite

IOleContainer (optional)

IContinueCallBack (optional)

Microsoft Internet Explorer is a traditional Single Document Interface host application and allows the end-user to edit only one document at a time. There is only one document in each frame and only one frame for the entire application. Additional documents require additional instances of the application.

In a traditional Multiple Document Interface (MDI) Host Application the main application window implements:

IOleInPlaceFrame

IOleCommandTarget

and each document window implements:

IOleClientSite

IAdviseSink

IOleDocumentSite

IOleInPlaceSite

However, even though multiple documents are open, only one document can be edited at a time. The document being edited occupies the whole window and there is no provision for viewing documents side-by-side. In an MDI environment, there is only one IOleInPlaceFrame, and because each IOleInPlaceFrame can have only one In-Place-Active-Object, only one of the open ActiveX Documents can be In-Place-Active at any one time.

The illustrative embodiment of the present invention uses Parallel-Frame-Technology with the result that in the main application window no Doc Object interfaces are needed but each document window implements:

IOleInPlaceFrame

IOleCommandTarget

IAdviseSink

IOleClientSite

IOleDocumentSite

IOleInPlaceSite

IOleContainer (optional)

IContinueCallBack (optional)

The implementation of Parallel-Frame technology results in a number features. As shown in FIG. 4, the Excel spreadsheet 104 is open side-by-side with a several other (including Word) documents 106. The menu bar along the top of the screen shows the menus appropriate for the current document (the Excel spreadsheet). Toolbars specific to the documents are shown in individual document windows instead of being shown along the top of the main window. The end-user can see toolbars for both the Word document and the Excel spreadsheet near the top of their corresponding windows

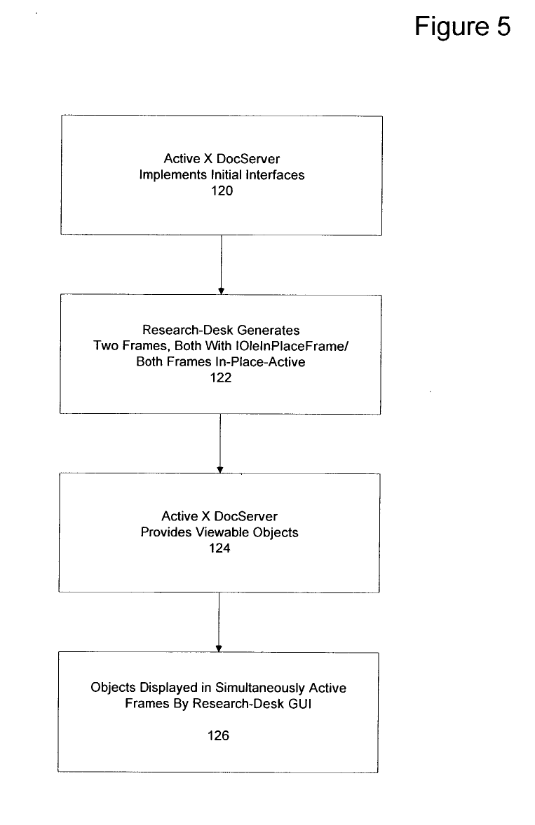

FIG. 5 is a flowchart of the sequence of steps performed by the illustrative embodiment of the present invention in implementing Parallel Frame Technology. The sequence begins when the ActiveX DocServer implements the intial interfaces required for a first frame (step 120). The Active X DocServer then implements the interfaces required for a second frame (step 122). In both cases, IOleInPlaceFrame is implemented resulting in both frames being In-Place-Active. The Active X DocServer provides a viewable object for each frame (i.e.: a document or Active X Control, etc.) (step 124). The viewable objects are then displayed in the implemented frames on the Active X host (step 126).

Parallel Frame Technology places greater memory and resource demands on Operating System and on DocObject server applications than the traditional hosting method of only implementing one frame per application. Accordingly, during low-memory or high-resource-usage situations, Research-Desk, silently destroys frames of In-Place-Active DocObjects if the user is not immediately interacting with that frame. A snapshot image of the frame is substituted to maintain visual consistency. When the end-user clicks on the image of the hidden frame, Research-Desk instantly replaces the image with a newly created frame that hosts the In-Place-Active DocObject. This technique of replacing a frame with an image significantly reduces the demands on the Operating System and on DocObject servers while maintaining full responsiveness. The double-buffered snapshot substitution and subsequent replacement process utilized by the illustrative embodiment of the present invention requires less than ½ second on most computers and allows full control over toolbar placement, the effective behavior of having multiple Doc-Objects simultaneously UI active, and no visual flash or delay when switching between documents.

To keep the user interface simple and intuitive, only one object (ActiveX Document) should be interacting with the user at a time. Research-Desk calls each of the ActiveX Documents' IOleInPlaceActiveObject::FrameWindowActivate methods so that the DocObject server only sees one host active at a time. This maintains consistency with the Microsoft Windows standard of having only one application interactive at a time—but other applications can maintain their internal and visual states until the end-user switches over to them. In the same manner, by using IOleInPlaceActiveObject::FrameWindowActivate, the DocObject server continues to behave as if each of the ActiveX Documents is hosted by a separate application and the applications are activated/deactivated as the user switches between documents in a single instance of Research-Desk.

The DocObject (ActiveX Document) specification provides an explicit mechanism for “merging” the menus of the DocObject server with the DocObject host. A DocObject server provides Edit, View, Insert, Format, Tools, Data, Help, and other menus that are merged with the menus (typically File, Window and Help) of the DocObject host. The end-user experience is enhanced because he sees a seamless superset of commands in the merged menus. Microsoft Windows implements several APIs (OleSetMenuDescriptor for example) and services to facilitate proper functioning of merged menus—commands are appropriately directed to the DocObject server and to the host. Unfortunately, the conventional method of merging menus suffers from said limitations. There are no easy way to merge toolbars in addition to menus. There is no support for modem applications (such as Microsoft Excel, Word, PowerPoint) that do not use Windows menu objects. Also, there is no easy way to support multiple In-Place-Active DocObjects in one application. Because multiple objects are simultaneously In-Place-Active, a method is need to arbitrate and dispatch menu commands to the appropriate DocObject.

Instead of relying on Windows DocObject related menu services, the illustrative embodiment of the present invention uses a Menu-Proxy Object. The Menu-Proxy object overcomes each of the aforementioned limitations and allows\merging of both toolbars and menus, full support for custom menu and toolbar controls and full support for multiple simultaneously In-Place-Active DocObjects. The Menu-Proxy Object acts as a go-between between the Windows menu created by COM for the DocObject host and the Windows menu provided by the DocObject server. The menu proxy object receives messages from the Research-Desk's custom Toolbars and menus, which are translated and dispatched to either Research-Desk or the DocObject server as appropriate.

Microsoft's DocObject (or ActiveX Document) specification requires that DocObject servers call the DocObject host's (i.e., the container's) IOleInPlaceFrame::SetMenu method when the DocObject is ready to set the menu bar. The call to SetMenu follows the DocObject previously callingIOleInPlaceFrame::InsertMenus to allow the host to ‘merge’ its menu with the menu bar that is provided in the IOleInPlaceFrame::SetMenu call. The standard method of implementing IOleInPlaceFrame::SetMenu is to call the Windows SetMenu and draw the menu bar on the host's window and then call OleSetMenuDescriptor APIs to let Windows manage dispatching commands from that menu bar onto the host or to the DocObject as appropriate. The Research-Desk Menu-Proxy Object alleviates the need for having Windows draw the menu bar or dispatch menu commands to the host and to the DocObject. The Menu-Proxy Object merges the menus and directs Research-Desk to draw its own menu bar. Then the Menu-Proxy object inserts itself into the event handlers for the Research-Desk menu bar so that it can arbitrate and dispatch menu commands back to Research-Desk or onto the DocObject as appropriate.

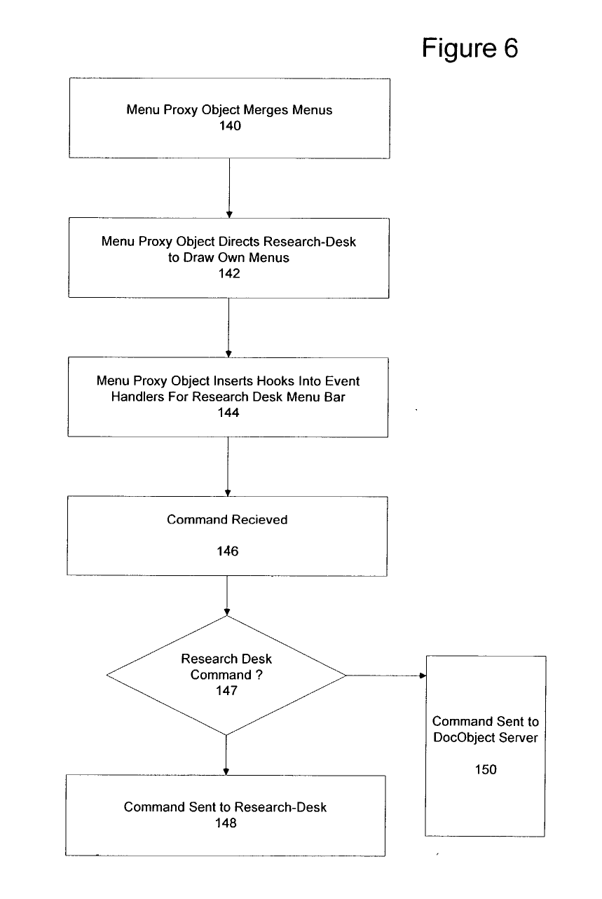

FIG. 6 is a flowchart of the sequence of steps followed by the illustrative embodiment of the present invention in using a menu-proxy object to merge menus. The sequence begins when the menu proxy object merges menu from the DocObject host and the DocObject (step 140). The menu-proxy object directs Research Desk 10 to draw its own menu bar (step 142). The menu proxy object then hooks into the event handlers for the Research Desk menu bar (step 144). Upon receiving an event notification (step 147), a determination is reached (step 146) as to whether the command should be handled by Research Desk 10 (step 148) or dispatched to the DocObject Server for processing (step 150).

The illustrative embodiment of the present invention also enables an Active X Control host to host an Active X document. The use of an Active X Control as a Host allows control over location and placement of ActiveX Documents so that they can occupy a small portion of the main window if desired. Control placement and appearance of the server's Toolbars and fine-grained control over the merging of the host's menus with the server also results.

Microsoft's COM Technologies, as it applies to visual components, has two basic specifications (ActiveX Documents and ActiveX Controls) with regard to hosting, displaying, and In-Place-Activating software components. ActiveX Document Technology is used mainly with document-intensive applications (such as Microsoft Word, Excel, PowerPoint, etc.) and allows the component server (e.g. Microsoft Excel) to display a document inside the window of a host application such as Microsoft Internet Explorer. ActiveX Control Technology, on the other hand, is used mainly with non-document components. For example, an ActiveX Control can provide the File-Open dialog—just the visual aspects—without providing any actual document reading features. Other popular ActiveX Controls include Toolbars and Menus which are visual but do not have any document components to it.

A byproduct of the difference between ActiveX Documents and ActiveX Controls is that ActiveX Document servers are designed to take over the whole (or a substantial portion) of the user interface—typically including toolbars and menus—of the host. This can be experienced in both Microsoft Binder and Internet Explorer when viewing an ActiveX Document such as an Excel Spreadsheet. ActiveX Controls on the other hand, are designed only to occupy a small portion of the hosts window and do not generally have the ability to take over the user interface of the host. An example of this is viewing a Flash presentation in Internet Explorer.

The illustrative embodiment of the present invention provides an ActiveX Control (the “Adapter”) that functions as an adapter. For the host of the ActiveX Control, the Adapter provides the standard interfaces and methods of an ActiveX Control. For the ActiveX Document itself, the Adapter provides a fully featured ActiveX Document host frame and document site with the appropriate interfaces and methods. As necessary, the Adapter translates the function calls on the ActiveX Control interfaces to function calls on the ActiveX Document interfaces. Additional features of the ActiveX Document are provided through IDispatch based Late-Binding (which allows the Adapter's ActiveX Control host to query for availability of functions).

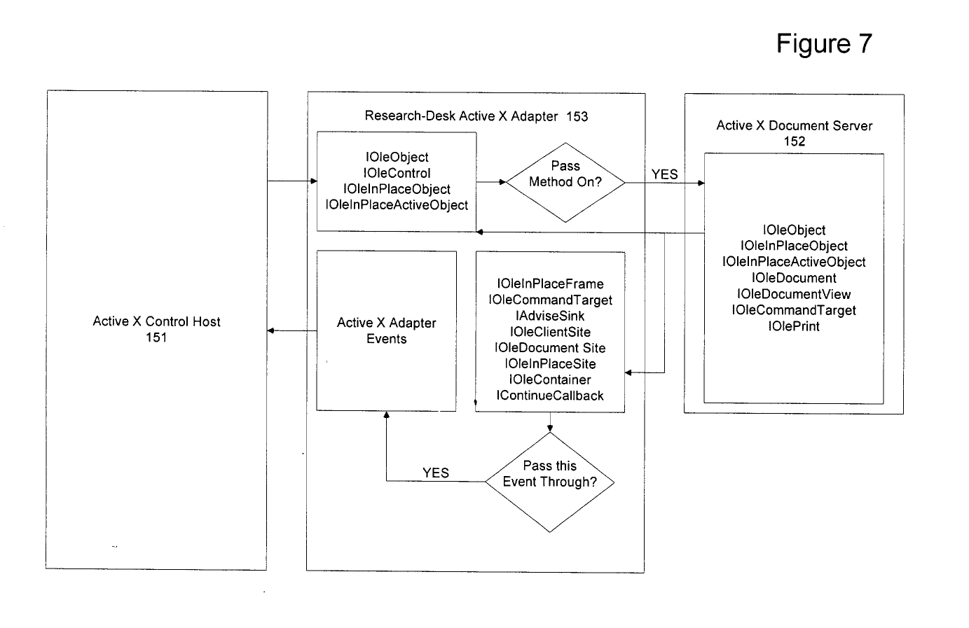

The Research-Desk ActiveX Adapter (which is a specialized ActiveX Control) implements some of the enhanced features of ActiveX Controls to communicate the ActiveX Document specific features. The ActiveX Adapter implements an outgoing interface called ActiveX Adapter Events that passes ActiveX Document specific information and method calls to the adapter's host. For example, whenever the ActiveX Adapter receives calls on its IOleCommandTarget interface (e.g., IOleCommandTarget::Exec or IOleCommandTarget::QueryInterface), the Adapter raises events (OnOleCommandTargetExec and OnOleCommandTargetQI respectively for the previous example) to provide the Adapter's host a chance to handle the method calls. In addition to the standard ActiveX Control interfaces, Research-Desk ActiveX Adapter also implements a dual incoming interface (on its ActiveX Control side) to support both IDispatch (which allows method discovery) and a native interface (for maximum performance). The dual interface contains methods that correspond to those implemented on ActiveX Document specific interfaces that are not normally available on the ActiveX Control. For example, the Adapter contains methods called Activate and Deactivate which are forwarded to the ActiveX Document's IOleInPlaceActiveObject::FrameActivate method. The Adapter also handles and forwards method calls on its ActiveX Control related interfaces to the hosted ActiveX Document. For example, a call to the Adapter's IOleInPlaceObject::SetObjectRects is forwarded to the same method on the ActiveX Document. Research-Desk uses ActiveX Adapter Technology to provide fully contained ActiveX Documents inside web pages. FIG. 7 depicts a block diagram of the data flow through the Research-Desk Active X Adapter. An Active X Control Host 151 and Active X Document Server 152 are separated by the Research Desk Active X Adapter 153. The Research Desk Active X Adapter 153 acts as an intermediary and decides with methods and events to handle and which to pass on to the Active X Document Server 152 and Active X Control Host 151 respectively.

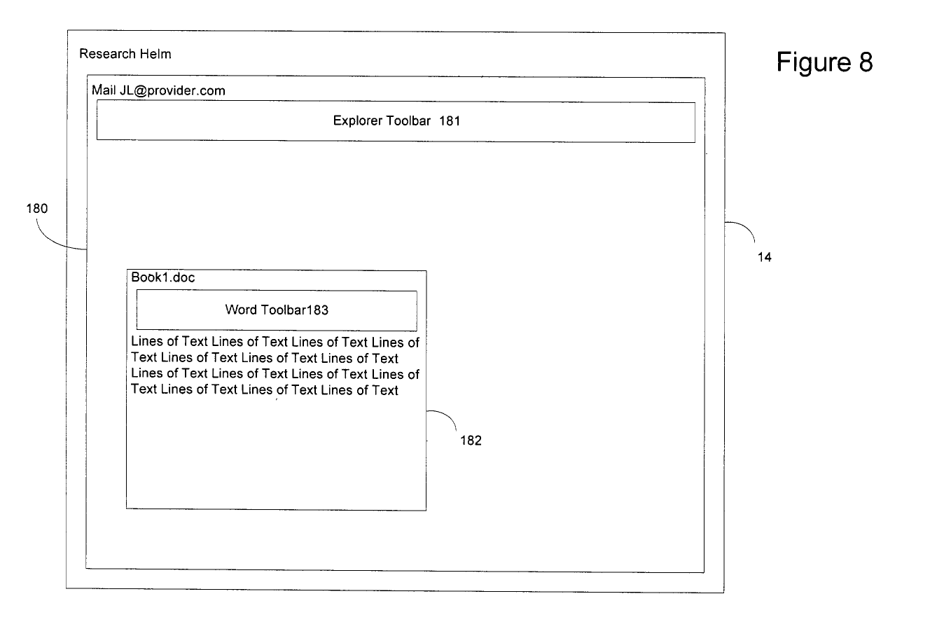

The placing of fully contained Active X documents inside web pages allows an end-user to use Microsoft Word to edit text areas in the web pages. FIG. 8 depicts a block diagram of the graphical user interface provided by Research desk 14 hosting a web page 180 with an Active X Word document 182 inside the web page. Both the web page 180 and Word document maintain their appropriate toolbars 181 and 183. A user can take advantage of the word processing capabilities of Word, such as grammar and spell-checking, within the text area on the web page 180.

In another aspect of the present invention, Research-Desk analyzes user activity prior to a popup browser window appearing to determine if the popup is user-requested. Research-Desk maintains a journal of user activity and the journal is analyzed to determine whether a popup browser window is to be allowed to appear or not. This is a much more effective means of blocking advertising popup windows while allowing desirable, user-initiated popup windows. Existing popup blocking software relies on a combination of three methods to determine whether the new window is a popup. First, the popup-blocking software screens the URL against URLs of known popup advertisers. Second, the popup-blocking software uses the window size as an indication of whether it is a popup—typically, windows sized less than a quarter of the screen are usually considered popup advertisements to be screened out. Third, the popup-blocking software determines if the popup window was created via script on the web page. Any such popup window is blocked or all such commands in scripts are disabled. Unfortunately, these methods also block desirable, non-advertisement popup browser windows. For example, web-based email sites such as Yahoo display popup windows to allow the end user to attach documents to their email messages. A web site that offers pictures may first show a window with a grid of small-sized images which, when clicked, show a new popup window with a full sized image.

To avoid the problems presented by conventional popup window blocking technology, at startup, Research-Desk uses the Windows API function SetWindowsHookEx to insert itself into the Windows keyboard and mouse hook chains (WH_KEYBOARD and WH_MOUSE). Research-Desk implements an object—called the HOOKDLL—which filters mouse and keyboard messages as Windows receives them. All Microsoft Windows systems starting from Windows 98 or with Internet Explorer 4.0 or above implement Microsoft's Active Desktop technology. At startup, Research-Desk creates in instance of the ShellWindows object (implemented by Active Desktop or Internet Explorer 4.0 or later). Research-Desk then sets up an event sink ShellWindows Event Sink—to capture events fired by the Shell Windows object. Each time Research-Desk creates a web browser window (using MSHTML.DLL and SHDOCVW.DLL's web browser control), Research-Desk sets up event sinks to handle events that occur in the web browser control. The Research-Desk object—Web Browser Event Sink—receives and processes events from the Web Browser Control.

The HOOKDLL receives an event for each mouse movement, mouse button press and mouse button release. The HOOKDLL also receives an event for each key press and key release. Mouse movements are not considered indicative of the user's intent with regard to web browser navigation and popup windows. Mouse presses, mouse releases, key presses and key releases are considered indicative. The HOOKDLL therefore maintains a log of all four of the indicative events. The log contains type of event (key press, key release, mouse press, mouse release), a time stamp, the location of the mouse pointer at that time, the window that will receive the action, and the state of the keyboard modifiers (whether CTRL, Shift or Alt are pressed) at the time of the event. This log can then be accessed when deciding whether to allow a new browser window. Those skilled in the art will recognize that Windows 2000 and XP support an API called GetLastInputInfo. This API obviates the need for hooking keyboard and mouse events as GetLastInputInfo provides similar information of the most recent keyboard or mouse event but is not implemented in earlier versions of Microsoft Windows—95, 98, ME, and NT4—do not implement the GetLastInputInfo API. Depending on the operating system, either API may used without departing from the scope of the present invention.

The Research-Desk Web Browser Event Sink receives a NewWindow event from the web browser control any time the web browser control is about to create a new window. The Web Browser Event Sink can return Cancel=True to disallow creation of the new window. In Web Browser Event Sink's NewWindow2 implementation, the mouse and keyboard log data is accessed to determine whether the new window is considered a popup. Whenever Research-Desk closes a browser window (i.e., destroys an instance of the web browser control), Research-Desk sets an application wide flag to True. The flag is set back to False after the web browser control has been properly terminated. The flag is returned to a false condition so that Research-Desk can monitor any new popup browser windows that are created during the ‘twilight zone’ (i.e., the process of terminating the web browser control). If a new popup browser window is created during the twilight zone, NewWindow/NewWindow2 events are not fired. This is why it is important to have the ShellWindows Event Sink. If a popup browser window is created during the twilight zone, it will open a new instance of Internet Explorer, which will cause the ShellWindows object to fire a WindowRegistered event. Research-Desk's handler for the WindowRegistered event checks if g_BrowserWindowClosing is True, and closes the new browser window if that is the case. Those skilled in the art will recognize that while the window blocking technology described above may be implemented as a part of Research-Desk, it may also be implemented as a add-on software application that works in conjunction with a web browser such as Internet Explorer or Netscape Navigator. The technology may also be used in conjunction with existing popup blocking methods (such as filter on URLs, or window size) to further enhance its reliability in distinguishing between desirable and undesirable popup browser windows.

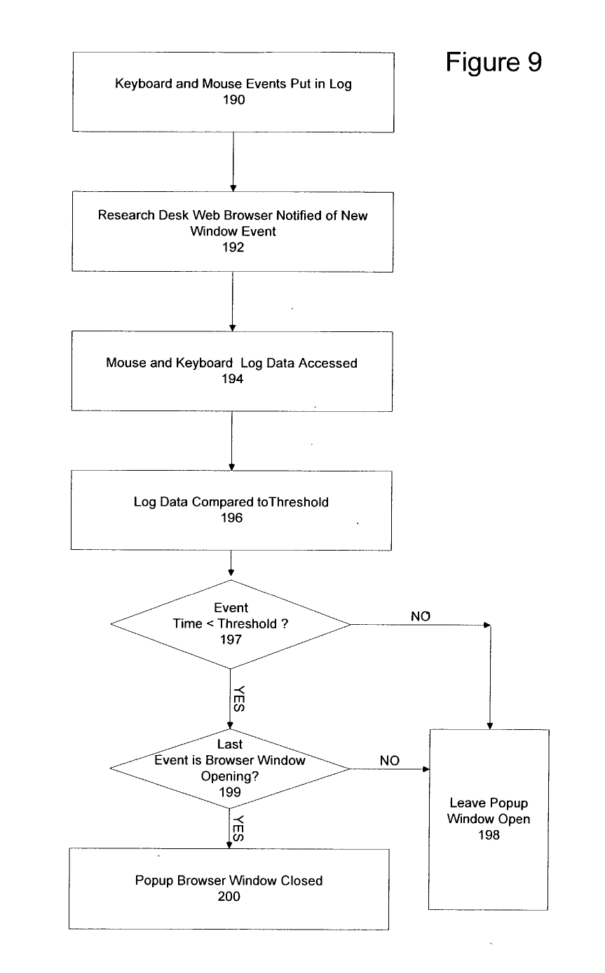

FIG. 9 is a flowchart of the sequence of steps followed by the illustrative embodiment of the present invention to prevent popup windows. The sequence begins as keyboard and mouse events are placed in a log along with their time of execution (step 190). The research desk web browser is notified of the creation of a new window (step 192). The most recent mouse and keyboard data is retrieved from the log (step 194) and the log data is compared to a threshold (step 196). A determination is made as to whether the mouse or keyboard event occurred within a predetermined time threshold of the creation of the new triggering event (step 197). If the event did occur within the threshold, the event is analyzed to determine whether it was a new popup window (step 199). If the new event was a new popup browser window, the window is closed (step 200).

In another aspect of the present invention, Research-Desk features an enhanced implementation of a web page archiving feature. HTML document(s) and web page elements constituting the page are retrieved from browser's cache whenever possible, instead of being retrieved from the server that hosts the web site as is done by conventional web page archive features. The use of the browser's cache provides several advantages. First, the function works much faster because most elements are retrieved from the relatively fast browser cache instead of a relatively slow Internet connection. Secondly, web pages that change/update on refresh or re-retrieval are saved properly. Many web sites, especially when serving secure (HTTPS or SSL) web pages to facilitate e-commerce transactions, do not allow the client to retrieve the same web page more than once. This means that the most common scenario—saving a web page that is currently being displayed by the browser—will not work because the web page would have retrieved once for display and therefore the second retrieval (to save) will fail. Cache integration bypasses this problem by reading the web page's contents and elements directly from the browser's cache therefore alleviating the need for a second request to the server hosting the web site. In order to view saved web pages, Research Desk reverses the process. Each of the elements comprising the web page are restored to the web browser cache and the web browser's cache index is updated to reflect the restored web page. Then the browser is directed to display the saved web page from the cache instead of the Internet.

An alternative implementation of the web page archiving process is also possible. Although the web browser cache exists on the computer's hard disk, depending on available memory, the same information is often also retained in the computer's RAM. Before checking the cache to see if the element is present, Research-Desk directs the web browser control to provide a pointer to the HTML Elements in-memory byte stream. If the pointer is successfully acquired then the byte stream can be saved to the hard drive. Checking the cache is a fallback if the pointer were not successfully acquired. And, as a final resort, if neither the in-memory stream nor the cache contained the information, Research-Desk can download the HTML Element from the URL. Accessing the in-memory stream is an important workaround for elements that are not cached.

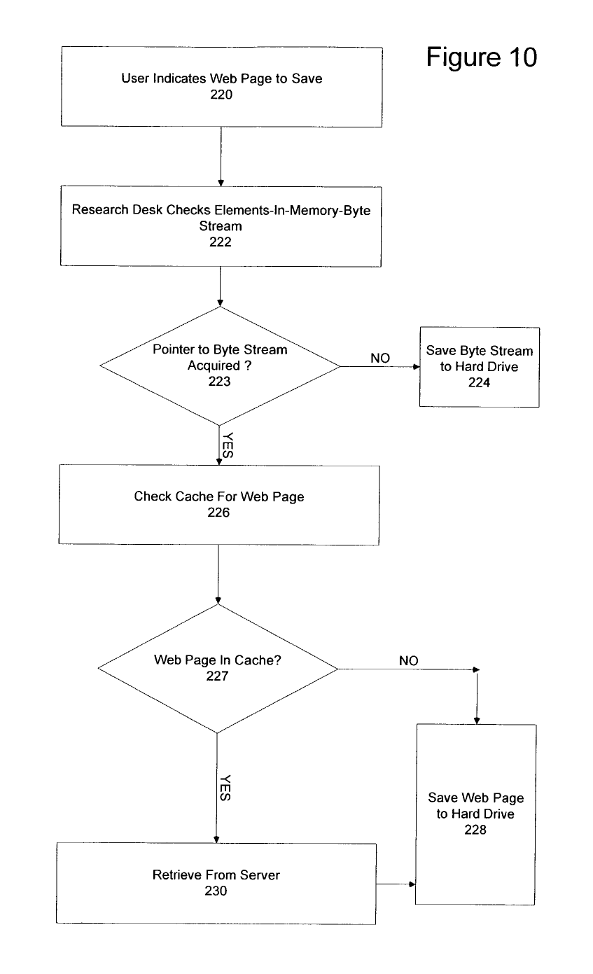

The sequence of steps used by the illustrative embodiment of the present invention to archive web pages is shown in FIG. 10. The sequence begins when a user indicates a desire to save a web page (step 220). Research-Desk checks the Elements-in-Memory Byte Stream (step 222) for the presence of the web page in RAM. A determination is mades as to whether a pointer to a byte stream has been acquired (step 223). If the pointer is acquired, the byte stream is saved to the hard drive. If the pointer to the byte stream is not acquired, Research-Desk checks the web cache for the web page (step 226). A determination is made as to wheteher the web page is present in the cache (step 227). If the web page is present in the cache, the web page is saved to the hard drive(step 228). If the web page is not present in the cache, the web page is retreieved from the server (step 230).

In another aspect of the present invention, Research-Desk can also filter URL requests made by the web browser control. When filtering, Research-Desk can save the results of the URL requests into a separate cache which can then be used to rapidly save a web page. Filtering URL requests can be accomplished via several methods including a HTTP Proxy, a “pluggable protocol handler”, and patching the implementation of the HTTP Download functions in WININET.DLL and SHDOCVW.DLL.

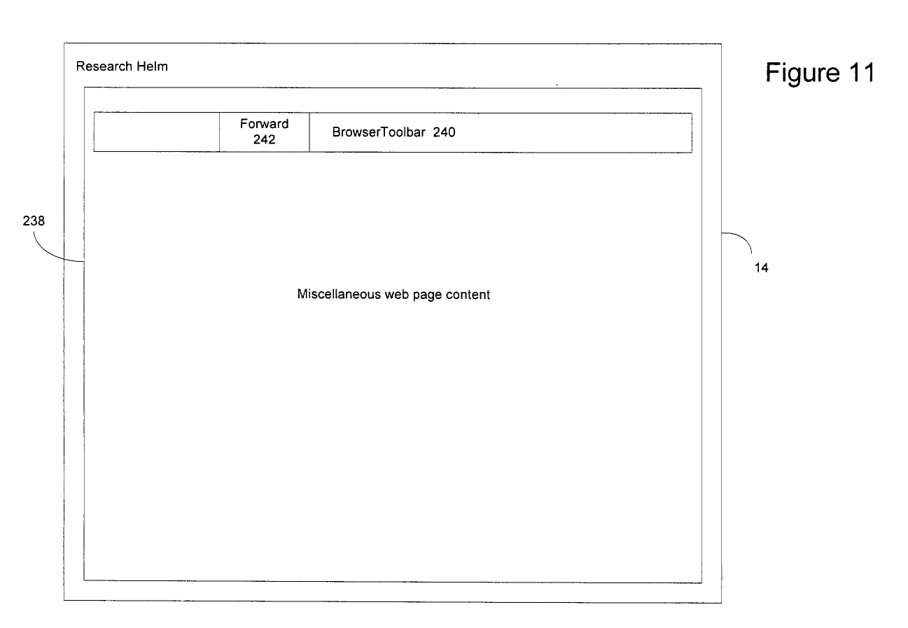

In an additional aspect of the present invention, the browser included with Research-Desk links multi-page web pages to browser controls. It is common practice for websites to divide a single article into multiple pages. This practice not only makes the pages easier to read (by reducing the need for vertical scrolling), but also enables the websites to display more advertisements and therefore better monetize their content. However, multi-page web pages require the user browsing the website to locate and click on buttons or links to view each subsequent page of the article. Research-Desk's Smart Forward technology analyzes the contents (the underlying HTML) of the web page and determines the most likely “next page” in the sequence. Research-Desk then makes this page easily accessible by linking the page to various easy to access parts of the user interface such as the Browser's “Forward” Button and mouse and keyboard shortcuts (such as ALT+Right Arrow). Also, if there is sufficient bandwidth, Research-Desk downloads the next page and keeps it cached on the user's PC to dramatically speed up the browsing session.Research-Desk analyzes the content by searching for keywords like “next”, “more”, “continue” etc., located in or around links. Research-Desk also analyzes the URLs of links to determine if the URLs are a logical progression from the current page's URL (for example, a link to http://www.microsoft.com/page2.htm would be considered a logical progression from http://www.microsoft.com/page1.htm). Based on these two forms of analysis, Research-Desk assigns a ranking to each link and and the highest ranked link is considered the most likely next page. FIG. 11 depicts the Research-Desk browser 240 with a forward button 242 which user's may use to advance to the next page in a multi-page web page 238, prior to having visited the next web page.

Research-Desk can also host two other kinds of applications as components Windows Single Document Interface applications (WIN-SDI, e.g. Notepad), and Windows Multiple Document Interface applications (WIN-MDI, e.g., Adobe Photoshop)—even if they do not implement either of the ActiveX Control or ActiveX Document binary standards. The hosting process for WIN-SDI and WIN-MDI is considerably more complex than the process for hosting Active X Controls or Active X Documents. The complexity is due to the fact that WIN-SDI and WIN-MDI applications do not necessarily adhere to a binary standard for exposing functionality programmatically (i.e., exposing functionality to a third party developer not just the end-user). Some WIN-SDI and WIN-MDI do not even expose functionality at all. However, the majority of WIN-SDI and WIN-MDI applications use two Windows standards that Research-Desk uses to access their features—Active Accessibility and standard Windows menus and toolbars Active Accessibility is a Microsoft Windows feature that describes menu and toolbar items and layouts in such a way that a sight-impaired user can use standard third party software to “talk” him through the program's functions. Research-Desk can communicate and command a third party application via the Active Accessibility interfaces—for example, Research-Desk can invoke the File, Save command of an application via Active Accessibility. If an application uses standard Windows menus and toolbars, Research-Desk can use its Menu-Proxy Object to merge a hosted application's menus with Research-Desk's and also dispatch commands to the hosted application. Visual integration between research desk and the application is achieved by using Windows SetParent API to make the WIN-SDI or WIN-MDI application appear within the Research-Desk window. Research-Desk also intercepts the message stream (the WindowProc) of applications hosted in this manner. Message interception is achieved via a combination of two methods—by subclassing the WindowProc, and by using the HOOKDLL and WH_CALLWNDPROC and WH_GETMESSAGE hooks. If needed, the HOOKDLL can also set WH_MOUSE and WH_KEYBOARD hooks to intercept mouse and keyboard messages.

Some hosted applications (such as Microsoft Excel, Word, PowerPoint, and others) expose their menus, toolbars and other user interface elements programmatically (e.g., Microsoft Word exposes its user interface via the CommandBars object) and this can be another means—in addition to using Active Accessibility and Windows menu objects—for Research-Desk to control the hosted application.

In order for the Menu-Proxy Object to function and for cross-process WindowProc interception, Research-Desk “injects” appropriate code into the hosted application. The code may be injected in several ways. The code may be injected by allocating memory in the hosted application's address space using VirtualAllocEx, by loading the WIN32 Adapter DLL into the process using WriteProcessMemory, and by using CreateRemoteThread to code execution. Alternatively, the code may be injected by a global windows hook implemented by HOOKDLL automatically injecting HOOKDLL into all user processes. The code may also be injected by using AppInit_DLLs registry entry (not available on Windows 98). Research-Desk code can also be injected into the hosted application via an add-in if the hosted application supports add-ins (e.g., Microsoft Word and Excel support COM Add-Ins). Those skilled in the art will recognize that there are multiple ways of injecting code into the hosted application without departing from the scope of the present invention.

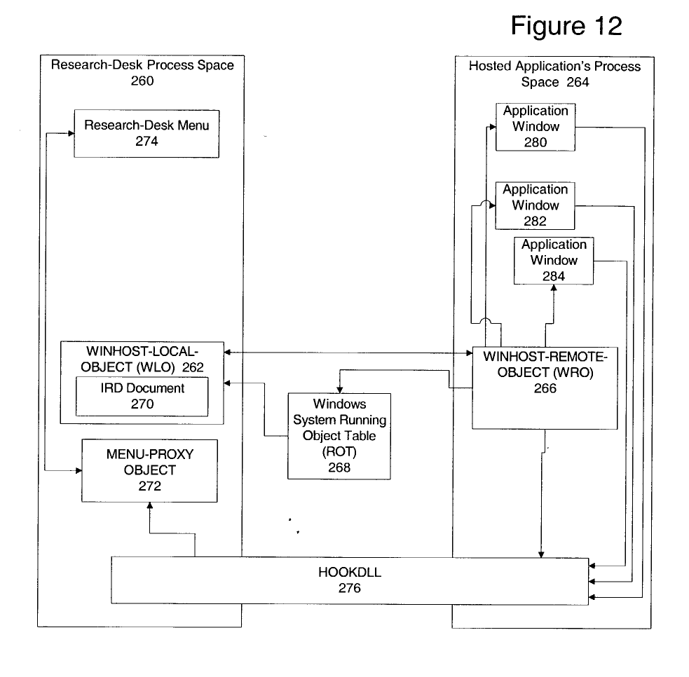

FIG. 12 depicts a block diagram of the environment in which Research-Desk hosts SDI and MDI applications as components even if they do not implement either of the ActiveX Control or ActiveX Document binary standards. The combination of techniques—ActiveAccessibility, Menu-Proxy Object to hook menus, HOOKDLL to intercept Windows messages, creating and communicating with remote threads and objects, and other necessary related tasks are accomplished by two components, the WINHOST-LOCAL-OBJECT (WLO) 262 in the Research Desk process space 260 and the WINHOST-REMOTE-OBJECT (WRO) 266 in the Hosted Application's process space 264. The WRO 266 is used to communicate with the hosted application windows 280, 282 and 284. Windows' Running Object Table (ROT) 268 provides registration and Common Object Model (COM) provides cross-process communication. Because Active Accessibility implementation and Windows menu usage is often idiosyncratic and different from application to application, Research-Desk uses a custom WRO for each hosted application. However, the WLO is common to all hosted WIN-SDI and WIN-MDI applications. WLOs are easily integrated with Research-Desk because they implement and expose Research-Desk's binary standard IRDDocument interface 270. WLOs also implement IDispatch to facilitate initialization via an Initialization Sequence XML file. And finally WLO's also use a Menu Descriptor XML file to describe menus and functions implemented by the hosted application. The menu proxy object 272 is used to implement two way menu status and command communication in conjunction with the research desk menu 274. A global windows hook implemented by HOOKDLL 276 is used to inject the code into the hosted application process space which allows the Menu-Proxy Object to function and enables cross-process WindowProc interception.

The techniques described herein are used by Research-Desk to gain full control of the hosted application's display and user-interaction in order to provide the end-user the effect of working with one seamless application. Similar techniques can also be applied to host WIN-MDI applications and host or automate Windows applications on other computers via DCOM (Distributed Common Object Model).

It will thus be seen that the invention attains the objectives stated in the previous description. Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

We claim:

1. In an electronic device with a plurality of executing applications, each said application generating at least one viewable object, a method, comprising the steps of:
providing a graphical user interface for a user of said electronic device, said graphical user interface providing access to each of said viewable objects; and
displaying simultaneously a plurality of active windows within said graphical user interface, each said window displaying at least one viewable object generated by one of said applications.

2. The method of claim 1 wherein said object is at least one of a DocObject and an Active X Control.

3. The method of claim 2, comprising the further step of:
deactivating a view in one of said plurality of active windows while leaving the window image unchanged; and
replacing said deactivated view in said one window with a new view generated by said application upon the user attempting to access said window image.

4. The method of claim 1, comprising the further step of:
saving the current state of said plurality of executing applications in a single workspace.

5. The method of claim 1, comprising the further step of:
saving the current state of only user-selected applications from among said plurality of executing applications in a single workspace.

6. The method of claim 1, comprising the further step of:
saving the objects generated by said applications with a single command.

7. The method of claim 1, comprising the further steps of:
receiving a single search command with said graphical user interface; and
searching each of said objects in response to said single search command.

8. The method of claim 1, comprising the further steps of:
mapping the menu commands from a first application from among said plurality of applications to a second application from among said plurality of applications; and
accessing said menu commands from said first application in said second application.

9. The method of claim 1, comprising the further step of:
dragging and dropping data from an object produced by a first application from among said plurality of applications to an object produced by a second application from among said plurality of applications.

10. The method of claim 1, comprising the further steps of:
providing a menu proxy object, said menu proxy object merging menus from said executing applications with a menu of said graphical user interface;
intercepting messages intended for said executing applications using HOOKDLL;
processing said intercepted messages using said menu proxy object.

11. The method of claim 10 wherein said executing applications are at least one of a Single Document Interface (SDI) document and a Multiple Document Interface (MDI) document.

12. In an electronic device with a plurality of executing applications, each said application generating at least one Active X document, a method, comprising the steps of:
providing a graphical user interface for a user of said electronic device, said graphical user interface providing access to each of said Active X documents; and
displaying simultaneously a plurality of active frame windows within said graphical user interface, each said frame window displaying one of said Active X documents.

13. The method of claim 12, comprising the further steps of:
implementing IOleInPlaceFrame for each frame window hosting one of said Active X documents.

14. The method of claim 13, comprising the further step of:
preserving Undo states for each Active X document when switching focus between said frame windows.

15. The method of claim 12, comprising the further steps of:
displaying a first browser window;
logging mouse and keyboard events;
receiving notice of the occurrence of a new window being displayed by said graphical user interface;
comparing the intial display time of said new window to the log of said mouse and keyboard event times to determine if the compared times are within a predetermined parameter; and
closing said new window based on the comparison of times.

16. The method of claim 12, comprising the further steps of:
displaying a first browser window;
retrieving a web page from a web server directly to a browser cache;
displaying said web page in said browser window by retrieving the web page from said cache.

17. The method of claim 12, comprising the further steps of:
displaying a first browser window;
retrieving the first page of a multi-page web page;
analyzing programmatically said first page of said multi-page web page to determine a reference to a next sequential page in said multi-page web page; and
linking said determined next page to at least one browser control.

18. In an electronic device with a plurality of executing applications, each said application generating at least one document, a medium holding computer-executable steps for a method, said method comprising the steps of:
providing a graphical user interface for a user of said electronic device, said graphical user interface providing access to each of said documents; and
displaying simultaneously a plurality of active windows within said graphical user interface, each said window displaying an object generated by one of said applications.

19. The medium of claim 18 wherein said object is a DocObject.

20. The medium of claim 19 wherein said method comprises the further steps of:
deactivating a view in one of said plurality of active windows while leaving the window image unchanged; and
replacing said deactivated view in said one window with a new view generated by said application upon the user attempting to access said window image.

21. The medium of claim 18 wherein said method comprises the further step of:
saving the current state of said plurality of executing applications in a single workspace.

22. The medium of claim 18 wherein said method comprises the further step of:
saving the current state of only user-selected applications from among said plurality of executing applications in a single workspace.

23. The medium of claim 18 wherein said method comprises the further step of:
saving the documents generated by said applications with a single command.

24. The medium of claim 18 wherein said method comprises the further steps of:
receiving a single search command with said graphical user interface; and
searching each of said documents in response to said single search command.

25. The medium of claim 18 wherein said method comprises the further steps of:
mapping the menu commands from a first application from among said plurality of applications to a second application from among said plurality of applications; and
accessing said menu commands from said first application in said second application.

26. The medium of claim 18 wherein said method comprises the further step of:
dragging and dropping data from a document produced by a first application from among said plurality of applications to a document produced by a second application from among said plurality of applications.
